(19) United States
(12) Patent Application Publication
(10) Pub. No.: US 2021/0172834 A1
(43) Pub. Date: Jun. 10, 2021

(54) METHOD AND CONTROL DEVICE ASSESSING THE DAMAGE TO A LOAD-CARRYING COMPONENT

(71) Applicant: ZF Friedrichshafen AG, Friedrichshafen (DE)

(72) Inventor: Stephan SCHINACHER, Egesheim (DE)

(21) Appl. No.: 16/771,720

(22) PCT Filed: Nov. 15, 2018
(86) PCT No.: PCT/EP2018/081289

§ 371 Date: Jun. 11, 2020

(30) Foreign Application Priority Data
Dec. 13, 2017 (DE) 10 2017 222 545.9

(51) Int. Cl. G01M 13/022; G05B 23/02; B60W 30/186; B60W 30/184

(52) U.S. Cl. CPC G01M 13/022; G05B 23/0283; B60W 2530/14; B60W 30/1846; B60W 30/186

(57) ABSTRACT

A method for assessing the damage to at least one load-carrying component of a working machine, an actual load collective is determined during operation of the at least one load-carrying component and, on the basis thereof, an actual degree of damage to the at least one load-carrying component is determined. At least one test load collective is retained, which is determined during testing of the at least one load-carrying component, in order to derive from such testing a test degree of damage. During the method, the test degree of damage is compared with the actual degree of damage and at least one control signal is emitted on the basis of the comparison between the at least one test degree of damage and the actual degree of damage.

This application is a National Stage completion of PCT/EP2018/081289 filed Nov. 15, 2018, which claims priority from German patent application serial no. 10 2017 222 545.9 filed Dec. 13, 2017.

### FIELD OF THE INVENTION

The invention relates to a method and a control unit for assessing the damage to at least one load-carrying component of a working machine. In particular, the invention relates to an improved damage assessment of load-carrying components by taking account of a test load collective and an effective existing actual load collective, in order to ensure safer operation of the working machine.

### BACKGROUND OF THE INVENTION

Methods and control units for damage assessment are known from the prior art. In particular, methods for the creation of load collectives are known, with which the design and testing of new developments can be carried out. It has been shown that when new concepts are used, such as continuously variable drives in working machines, the drive-trains used in certain applications are subjected to substantially higher stresses than they were originally designed for.

The prior art according to DE 10 2015 120 203 describes a method for determining a stress to which a vehicle is subjected. In this method driving maneuvers are classified in terms of their intensity and from that, key stress data are generated.

### SUMMARY OF THE INVENTION

A method for assessing the damage to at least one load-carrying component of a working machine comprises the following steps: determination of an actual load collective during the operation of the at least one load-carrying component, and determination of an actual degree of damage of the at least one load-carrying component on the basis of the actual load collective determined. In addition the method comprises the following steps: retention of at least one test load collective determined during the testing of the at least one load-carrying component, in order to derive a test degree of damage, and derivation of the test degree of damage from the at least one test load collective, comparison of the test degree of damage with the actual degree of damage, and output of at least one control signal on the basis of the comparison of the at least one test degree of damage with the actual degree of damage.

In this method the at least one test load collective is defined by predetermined information about the amplitude and frequency of stresses on the at least one load-carrying component, over time. In addition, in the method the step of determining the actual load collective can include an accumulation of information about the amplitude and frequency of stresses on the at least one load-carrying component detected during its operation, over time.

The load-carrying component can be an element or an assembly. The element or assembly can be provided in order to transfer a load. In particular the load-carrying component can be an element or an assembly of a drive-train. The drive-train can then be provided in a working machine. The working machine can be any self-propelling machine, such as an agricultural machine, a construction machine, a forestry machine or the like. The loading of the load-carrying component is for example brought about by the transmission of drive power from a drive source such as an internal combustion engine or some other drive mechanism to drive wheels.

The test load collective can be created during the testing phase in which the load-carrying component concerned, or part or the whole of the surroundings of the load-carrying component, is tested. The test collective can be created by predetermined load runs or field tests, and includes a predetermined sequence of loading with defined amplitudes and frequencies over time. In this context the loading can be understood to be a force, torque, or any other form of loading. The amplitude of the loading can be quantified as a function of the type of loading. When preparing the test load collective, the individual loads can be classified at least in relation to amplitude and frequency.

The actual load collective is determined during operation of the at least one load-carrying component by determining the loads imposed on the load-carrying component during actual operation. In this, the load can for example be a force or a torque acting upon the load-carrying component, for example measured by using a sensor or determined in some other way, in particular even estimated. For this, when used in a working machine the measurement technology already present in the vehicle can be used to detect the loading over time. When determining the actual load collective a classification of the loads at least according to amplitudes and frequencies is likewise carried out. For the sake of comparability, in the present method the test load collective is created and the actual load collective is determined on the basis of the same, or at least comparable conditions and assumptions. In particular, the same procedure can be used for both load collectives for the classification of amplitudes and frequencies.

From the test load collective, from examinations during the testing phase of the load-carrying component a test degree of damage can be derived. In particular, the test degree of damage can provide information about the damage to the load-carrying component after operation over a predetermined time span with loads of known amplitude and frequency. Likewise, from the actual load collective determined, an actual degree of damage can be determined, which gives indications about the amount of damage to the load-carrying component during actual operation of the working machine in which the load-carrying component is fitted. Thus, in the present method quantifiable degrees of damage are indicated in the form of the test degree of damage and the actual degree of damage.

In the method, the test degree of damage is compared with the actual degree of damage. From the comparison, a ratio between the actual degree of damage and the test degree of damage is determined, which can be used further in the method. The ratio is determined by dividing the actual degree of damage by the test degree of damage. The ratio can be expressed as a percentage and can be processed further. In the method at least one control signal can be emitted on the basis of the comparison of the at least one test degree of damage with the actual degree of damage.

In addition the method can include the step of retaining a plurality of test load collectives which differ in respect of the predetermined information about amplitudes and frequencies of loads on the at least one load-carrying component over time. For this, the prerequisite is that in the testing of the load-carrying component various load sequences or field testing sequences are carried out. In this, the various test load collectives are defined by various distributions of load amplitudes and frequencies over time. By retaining a variety of different test load collectives, the method can be optimized as much as possible and a more realistic comparison between the actual load collective and the test load collective can be carried out.

Furthermore, in the method the step of selecting one test load collective from among the plurality of test load collectives, taking into account the actual load collective determined, can be provided. In that case the test load collective selected is used in the step of deriving the test degree of damage. The selection of the test load collective can be carried out by comparing the characteristics of the loads in relation to amplitude and frequency over time, of the actual load collective with the available test load collectives. This procedure ensures that the determination of the ratio between the actual degree of damage and the test degree of damage is as accurate as possible.

Namely, in the method, in the step of comparing the test degree of damage with the actual degree of damage, a ratio between the actual degree of damage and the test degree of damage is determined and, in the step of emitting the at least one control signal, depending on the ratio determined, predetermined functions can be associated with the control signal. The quantifiability of the ratio by forming the quotient between the actual degree of damage and the test degree of damage, lays open the possibility of implementing various functions by means of the control signal. In this case the function associated with the control signal when the ratio has a high value can be different from that when the ratio is low.

It should be noted that the ratio between the actual and the test degrees of damage is 100% when the two degrees of damage have the same value. If the actual degree of damage exceeds the test degree of damage, the ratio adopts a value larger than 100%. If the actual degree of damage is less than the test degree of damage, the ratio has a value smaller than 100%.

In the method, as a function of the ratio determined in the step of comparing the test degree of damage with the actual degree of damage, the following function can be assigned to the control signal: provision of information about the expected residual lifetime of the at least one load-carrying component by estimating on the basis of the ratio determined between the actual degree of damage and the test degree of damage. Since the ratio between the actual and the test degrees of damage can be determined, it is possible particularly on the basis of empirical values and by evaluating the actual course of the ratio during operation, to estimate a residual lifetime of the load-carrying component. With the help of this functionality, an indication can be given to the operator of the working machine of how much time is still available for the expected trouble-free operation of the working machine. Moreover, from this information the operator of the working machine can derive an indication of whether the operating mode of the working machine has to be adapted, having regard to the estimated residual lifetime of which he has been made aware.

In the method, as a function of the ratio determined in the step of comparing the actual degree of damage with the test degree of damage, at least one of the following functions can be assigned to the control signal: a command to record a fault entry in a fault memory and/or to generate a warning message if a first ratio value is exceeded, a command to intervene in the operation of the working machine in order to reduce the loading of the at least one load-carrying component if a second ratio value is exceeded, whose value is larger than the value of the first ratio, or a command to operate the working machine in an emergency mode or to switch off the working machine if a third ratio is exceeded, whose value is larger than that of the second ratio.

With this procedure, taking into account the ratio between the actual degree of damage and the test degree of damage, the safe operation of the working machine can be ensured either by issuing a command to the operator or by intervening in the operation of the working machine, so that crucial damage to drive elements of the working machine can be avoided. During this, when the first ratio is reached a warning message is first sent to the operator so that in this case the operator can himself decide how the working machine is to be operated further. The entry of a fault in a fault memory can be evaluated for future maintenance work. As soon as the ratio exceeds a second value, an active intervention in the operation of the working machine can take place, namely for example by reducing the maximum torque of the drive machine, reducing the maximum rotational speed of the drive machine by permitting or preventing predetermined shift positions of a transmission, or in general by preventing operating situations which can give rise to undesired damage to the load-carrying component.

As soon as the ratio exceeds a third value, substantial damage to the load-carrying component is to be expected. In this case, to prevent crucial damage to the working machine or danger to the operator the operation of the working machine is adjusted or, as an alternative, an emergency mode function is initiated. The emergency mode function can include a predetermined operating mode in which, for example, the working machine can still cover a predetermined distance at lower maximum speed. Thus, despite the expectation of damage to the load-carrying component within a short time, the working machine can drive to a workshop for maintenance or to a safe place for parking.

In the method, the first, second and third ratios between the actual degree of damage and the test degree of damage can be varied as a function of an operating mode and/or a characteristic of the loading of the at least one load-carrying component. Having regard to the operating mode, which for example can be characterized by particularly severe use or use in surroundings with particular influences on the working machine, the values of the ratios can be adapted. With regard to the surroundings, for example the height above sea level, the air humidity and/or the temperature as well as other influencing factors can be taken into account for adapting the ratios.

In the method, the step of determining the actual load collective and/or the step of comparing the test degree of damage with the actual degree of damage can be implemented continuously, at least during the operation of the at least one load-carrying component. This continuous implementation is particularly appropriate in order to promptly provide the indication or the intervention by the control signal. This can prevent damage to the load-carrying component from taking place in the case that the above-mentioned steps are not implemented continuously, which damage would be anticipated by virtue of continuous implementation. However, a mode of implementation is also possible in which the above steps are carried out at predetermined time intervals.

The control unit for assessing the damage to the at least one load-carrying component of a working machine comprises a signal input for receiving a detection signal from a load detection element in order to detect a load on the at least one load-carrying component, a processor for processing the detection signal, and a signal output for emitting the at least one control signal. In addition, the control unit is provided with a memory device for storing information about at least one test load collective. The control unit can be designed to determine an actual degree of damage to the at least one load-carrying component on the basis of the detection signal from the load detection element, to derive a test degree of damage from the at least one test load collective stored in the memory device, and on the basis of a comparison between the test degree of damage and the actual degree of damage to emit a control signal associated with a predetermined function.

The control unit can be integrated in a central control unit of the working machine and, in addition to the aforesaid functions, can have further functions. These functions can include control of the combustion engine, control of hydraulic devices, control of electrical equipment, control of the brakes, and regulation of the steering.

The control unit can assign functions to the control signals that can be emitted via the signal output. These can include functions for the provision of information and/or functions for intervention in the operation of the working machine. The control unit is designed to carry out the method in accordance with the procedures described earlier. For this, the control unit comprises the appropriate means, for example the processor, the memory device, signal inputs and signal outputs and further necessary means if needed. The memory device can be integrated in the control unit. In that case the control unit comprises an interface for uploading data or information about the test load collective into the memory device. The memory device can also be designed as an exchange means. Moreover, data on the test load collective or other data can be transferred to the memory device by wireless means or via a bus system.

The control unit can be connected to detection elements of the working machine. The detection elements can be provided for the operation of drive devices such as a combustion engine of the working machine. In such a case, information about the loading of the at least one load-carrying component can be obtained from the detection devices already provided for the operation of the working machine. However, it is also possible to provide additional detection devices such as sensors and the like, with which the loading can be determined for preparing the actual load collective.

### BRIEF DESCRIPTION OF THE DRAWINGS

FIG. 1: A schematic representation of a control unit, according to an embodiment of the present invention;

FIG. 2: A process sequence of a method according to an embodiment of the present invention;

FIG. 3: A sequence of the method according to a modified embodiment of the present invention;

FIG. 4: A diagram showing the comparison of actual degrees of damage and test degrees of damage;

FIG. 5: A diagram showing an example of the variation of an actual degree of damage.

### DETAILED DESCRIPTION OF THE EMBODIMENTS

In what follows, embodiments of the present invention will be described with reference to the figures.

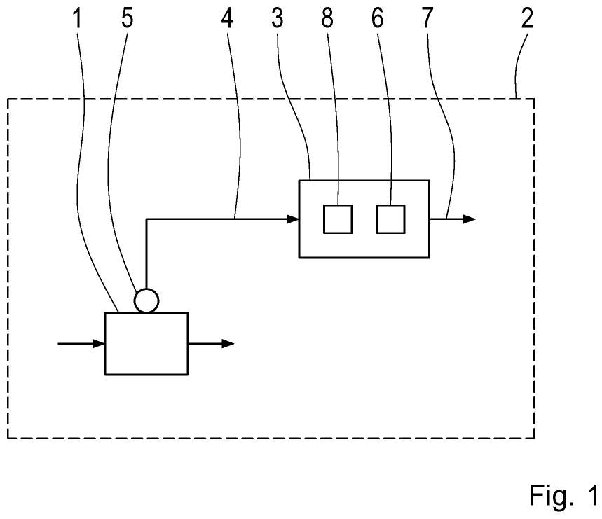

FIG. 1 shows a control unit 3, which is built into a schematically represented working machine 2. For simplicity some elements of the working machine 2, such as wheels, drive-train and internal combustion engine as the drive mechanism are not shown. The control unit comprises a processor 6, which is used for carrying out programs and processing data. In addition, the control unit 3 comprises a signal output 7 which can emit a control signal produced by the control unit 3 for further processing. In this embodiment the signal output 7 is coupled at least to a display device visible to the operator of the working machine. Furthermore, the signal output 7 is coupled to further devices of the working machine 2 not shown in the figure.

The control unit 3 also has a signal input 4 which delivers a signal from a load detecting element 5 to the control unit 3. The load detecting element 5 is designed to detect a load and to produce a signal that represents the load.

In the present embodiment, the working machine comprises a load-carrying component 1. The load-carrying component 1 is integrated in the working machine 2 and is provided in order to transmit a load within a drive mechanism of the working machine 2. The load acting upon the load-carrying component 1 is detected by the load detecting element 5.

In the following explanation of the embodiment the load-carrying component 1 is for example assumed to be a shifting clutch designed for shiftably transmitting torque from an input side to an output side. The input-side torque and the output-side torque determine the load that acts upon the shifting clutch. In this example, the load detection element 5 can be assumed to be a torque detection device which quantitatively determines the torque transmitted by the shifting clutch. In this case the load on the shifting clutch depends on the operating mode of the working machine, namely on the power introduced, which for example is delivered by a combustion engine, and by the reaction torque applied for example on wheels of the working machine.

In the present example the load detection element 5 emits a signal which passes into the control unit 3 by way of the signal input 4. The signal emitted by the load detection element 5 is produced continuously, so that the control unit 3 obtains information about the variation of the load over time, which in the present example represents the torque transmitted by the shifting clutch.

The memory device 8 provided in the control unit 3 is suitable for the storage of data required for the control unit 3 to carry out the method.

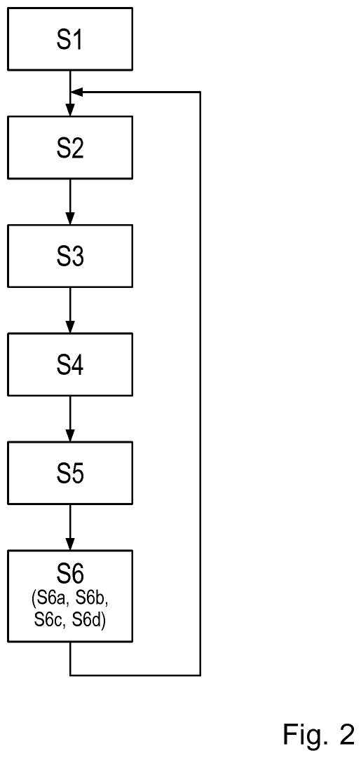

Below, a method is described for damage assessment in accordance with an embodiment, with reference to FIG. 2. In this case reference is made to the previously described example, in which the at least one load-carrying component 1 is taken to be a shifting clutch within the drive-train of the working machine 2.

The steps shown in FIG. 2 are carried out in the sequence shown, by means of the control unit 3 described above. In step S1, in the present embodiment a test load collective is retained, which was determined during the testing of the at least one load-carrying component. The test load collective is stored in the form of a data set in the memory device 8 of the control unit 3. The data on the test load collective stored in the memory device 8 remain available for further processing by the control unit 3.

The test load collective consists of a data set produced during the testing of a load-carrying component 1 or a working machine. To produce this data set, in the testing phase predetermined loads are applied over a period of time to the load-carrying component 1 and any damage to the load-carrying component over time is determined. Thus, in the above-mentioned example, in which the load-carrying component 1 is assumed to be a shifting clutch, a load variation as realistic as possible is created in that the shifting clutch is subjected to a torque with predetermined amplitude and frequency. In this connection, at predetermined time intervals the damage to worn elements of the shifting clutch is examined and the damage determined is assigned a degree of damage. In that way, during the determination of the test load collective a data set is produced, from which a degree of damage to the load-carrying component 1 over time can be inferred.

In step S2 an actual load collective is determined during the operation of the at least one load-carrying component 1. In this case, by means of the load detection element 5 the actual loading of the load-carrying component 1 is determined during on-going operation and passed on by way of the signal input 4 to the control unit 3 for further processing. The actual load collective is created in a similar manner to the test load collective, with the difference that data is obtained in real time and successively during the operation of the working machine. The data set constituting the actual load collective is stored in the control unit 3 for further processing.

In step S3, an actual degree of damage to the at least one load-carrying component 1 is determined on the basis of the actual load collective. For this, the principles used for deriving the degree of damage are similar to those used for deriving the test degree of damage on the basis of the test load collective. Various methods are available, but in the present embodiment the same or at least similar assumptions are made for determining the actual degree of damage as those for determining the test degree of damage.

Namely, in step S4 the test degree of damage is derived from the test load collective retained in step S1. In step S5 the test degree of damage derived in step S4 is compared with the actual degree of damage determined in step S3. Here, the actual degree of damage and the test degree of damage are quantitative values which can be quantitatively compared with one another. From the comparison carried out in step S5 a quotient is obtained between the actual degree of damage and the test degree of damage. That quotient is determined by dividing the actual degree of damage by the test degree of damage, and is processed further as a quantitative magnitude. This ratio is relevant for assessing the progress of damage to the load-carrying component 1.

In the following step S6 a control signal is generated on the basis of the comparison, in particular based on the ratio between the actual degree of damage and the test degree of damage expressed by the quotient, and this signal is emitted by way of the signal output 7 for further processing.

Thanks to the possibility of processing quantitative values of the ratio between the actual degree of damage and the test degree of damage in the control unit 3, various functions can be assigned to the signal emitted by the signal output 7. In particular, in a secondary step S6a information about the expected residual life of the load-carrying component 1 can be produced and made available. In such a case the expected residual life can be indicated to the operator of the working machine 2 on a display, so that the operator can decide for himself whether to continue operating. The expected residual life can be decided by estimating a time until, with the existing mode of operation, the ratio between the actual and test degrees of damage reaches a permitted maximum value. The permitted maximum value is reached when in the testing phase, on the basis of the test load collective, a failure of the load-carrying component 1 would take place with high probability.

Furthermore, in a secondary step S6b, when a ratio between the actual and test degrees of damage defined as the first ratio is exceeded, a command to record a fault entry is emitted as a signal via the signal output 7. The fault entry is made available for maintenance measures and can give indications about the damage and/or the amount of damage to the load-carrying component 1. With the ratio between the actual and test degrees of damage determined in step S6b, there is still no damage in a form that suggests a failure or operational limitation of the working machine 2. For example, the first ratio can be set at a value of 100%.

If the actual degree of damage and hence also the ratio between the actual and test degrees of damage increases further, then when a second ratio which is larger than the first ratio is exceeded, in the secondary step S6c, a command is issued via the signal output 7 to intervene in the operation. By integrating the control unit 3 in the overall control system of the drive device of the working machine 2, it is possible for example to limit a maximum output torque of the combustion engine or, with the shifting clutch as the load-carrying component 1, the torque it transmits can be reduced. By virtue of this procedure a failure of the load-carrying component 1 can be limited or the expected life of the load-carrying component 1 can be extended since the load imposed on the load-carrying component 1 is reduced. The second ratio can for example be set at a value of 120%.

If the ratio between the actual and test degrees of damage increases still more, then in a secondary step S6d, if a third ratio which is larger than the second ratio is exceeded, the command to operate the working machine in an emergency mode is issued via the signal output 7. An emergency mode is characterized by an operating mode of the working machine with minimal functions in which the working machine 2 can at least travel as far as a workshop for maintenance or to a safe parking place. Moreover, operation in the emergency mode also entails switching off any drive elements which are not needed for the above-described operating mode. In the case when there is a likelihood of crucial damage to the load-carrying component 1 or some other element of the working machine 2, in the secondary step S6d the switching off of the drive mechanisms of the working machine 2 can also be commanded via the signal output 7. The third ratio can for example be set at a value of 150%.

Overall, with the present method highly accurate information about the degree of damage to a load-carrying component 1 can be obtained. This is made possible by the comparison of the degree of damage determined during the testing phase as a function of the utilization of the working machine, with the actually existing degree of damage that can be derived by preparing the actual load collective.

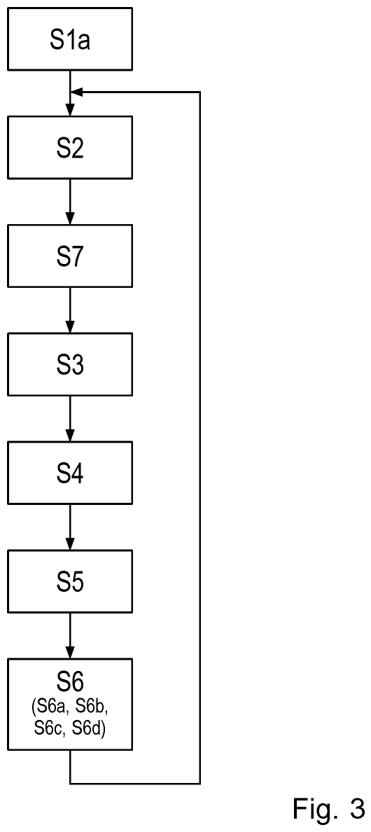

FIG. 3 shows a modified version of the above-described embodiment. In the process sequence shown in FIG. 3, the step S1 in FIG. 2 is replaced by a step S1a. In this modified form, in step S1a, a plurality of test load collectives is produced, which are stored in the memory device 8 of the control unit 3. As in the previous embodiment, in the next step S2 an actual load collective is determined during the operation of the at least one load-carrying component 1. However, in the modified embodiment, after step S2, a step S7 is inserted in which a test load collective is selected from the test load collectives retained in step S1a. Namely, with regard to the data on the actual load collective determined in step S2, in this embodiment an evaluation is carried out, which identifies from among the various test load collectives retained in step S1a the one which manifests the greatest similarity to the actual load collective determined in step S2. The procedure in step S7 is explained below.

As already described, the test load collective contains data about the amplitude and frequency of the loading, over time. This distribution of amplitude and frequency over time is predetermined during the testing, in order to be able to match the actual operation of the working machine 2 as closely as possible. When determining the actual load collective, it can be assessed, by way of a comparison with the actually existing amplitudes and frequencies of the loads, which of the test load collectives retained in step S1a best matches the previously determined actual load collective.

After the selection carried out in step S7, the test load collective chosen is used in the subsequent steps in order, if necessary, to emit the control signal with its associated functions as described in the preceding embodiment.

With this modified embodiment the accuracy of the results can be substantially improved and thus unexpected damage due to existing deviations between practice and testing can as far as possible be prevented.

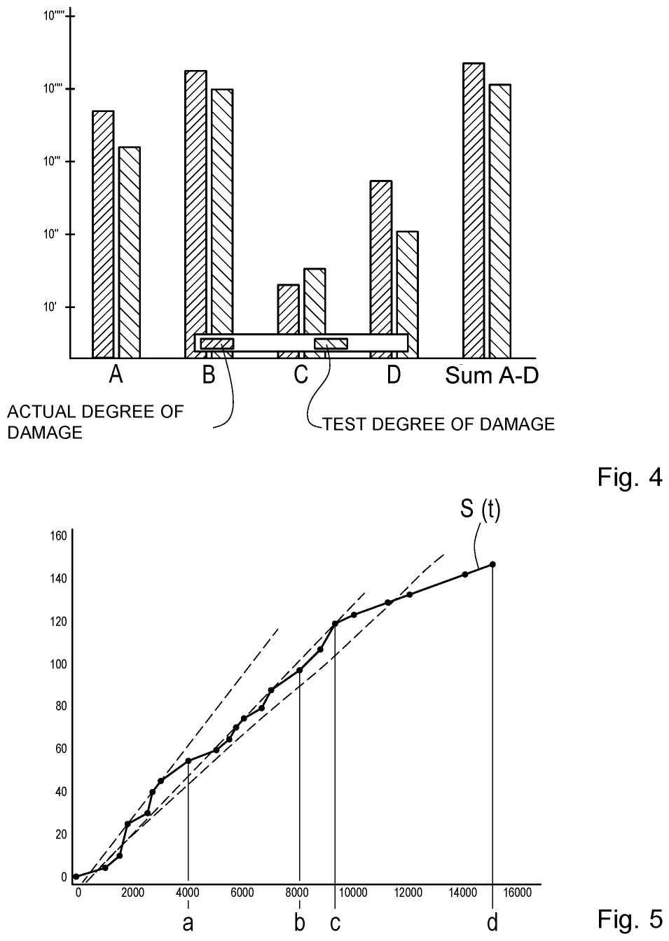

Concerning this, FIG. 4 shows an example of the comparison of an actual degree of damage and a test degree of damage in the form of a bar chart. In this case the values of the degrees of damage are entered logarithmically and are compared as shown in the diagram of FIG. 4 for various elements A-D in a specified time period, wherein in each case the bar on the right indicates the test degree of damage whereas the bar on the left indicates the actual degree of damage. As can be seen from FIG. 4, a plurality of load-carrying components 1 can in this way be evaluated and the values for the actual degree of damage and for the test degree of damage can then be summed for the elements A-D. The evaluation of the summed degrees of damage, namely the formation of the quotient between the summed actual degree of damage and the summed test degree of damage of the respective elements A-D, can then be used for the method described earlier.

FIG. 5 shows an example of the variation of the actual degree of damage as a function of time. In this case the ratio between the actual and test degrees of damage is plotted as a quotient, in percentage units, against the operating time of the working machine. The curve S(t) shows the variation of the quotients. At point a an operating time of 4000 h is reached and at that point in time an indication of the need for maintenance work, such as an oil change, can be given. At point b the ratio has reached a value of 100% and a fault can then be recorded in the fault memory in order to make available an indication that the actual degree of damage has become equal to the test degree of damage. At point c the ratio has reached a value of 120%. At this point the control unit 3 intervenes in the regulation of the working machine and reduces the power of the combustion engine. Thus, from point c onward the subsequent slope of the ratio decreases. At point d the ratio has reached a value of 150% and from that point the working machine is operated in an emergency mode or switched off completely.

It should be pointed out that in the above description the working machine 2 can be any working machine in which a load-carrying component 1 is provided, which component is prone to damage over the course of its utilization time. In particular the working machine 2 can be an agricultural machine, a building machine or a forestry machine or any other type of machine. Furthermore, in the above description, as an example, the load-carrying component 1 is said to be a shifting clutch used for the shiftable transmission of a torque. However, the load-carrying component 1 can be any other component subjected to loading, such as a transmission, a differential gearset, an individual gearwheel, a planetary transmission or the like. Moreover, the load-carrying component 1 can also be a belt drive, a chain drive, a universal shaft drive or suchlike. The loads described above have been discussed as forces or torques. However, the load acting upon the load-carrying component 1 can also be a pressure force, a thermal load, electrical power or some other load. In addition the load can also relate to an impact force.

In the above description the load has been discussed in relation to the load-carrying component 1. However, a load on a load-carrying component can also have effects upon the damage to another component. For example, damage to a transmission set can be estimated from the loading of a shifting clutch. In addition it is possible for other elements of the working machine, such as lubrication oil, filters, hydraulic cylinders and the like to be defined as components prone to damage during the course of operation.

Furthermore, the load-carrying component can be understood as an individual element or as an assembly in which a plurality of load-carrying elements are included, such as a multi-gear transmission with a plurality of gearsets, bearings and suchlike. The numerical values given for the ratios are only examples and can be adapted for the corresponding range of applications.

### INDEXES

1 Load-carrying component
2 Working machine
3 Control unit
4 Signal input
5 Load detection element
6 Processor
7 Signal output
8 Memory device
S1 Retention of at least one test load collective
S1a Retention of a plurality of test load collectives
S2 Determination of an actual load collective
S3 Determination of an actual degree of damage
S4 Derivation of a test degree of damage
S5 Comparison of the test degree of damage and the actual degree of damage
S6 Emission of a control signal
S6a Production of information on the expected residual life
S6b Command to record a fault entry
S6c Command to intervene in operation
S6d Command to operate in emergency mode or to switch off
S7 Selection of a test load collective

1-12. (canceled)

13. A method of assessing damage to at least one load-carrying component (1) of a working machine (2), the method comprising:
retaining (S1a) a plurality of test load collectives, which were determined during testing of the at least one load-carrying component (1), for derivation of a test degree of damage,
determining (S2) an actual load collective during operation of the at least one load-carrying component (1),
determining (S3) an actual degree of damage to the at least one load-carrying component (1) on a basis of the actual load collective determined,
deriving (S4) the test degree of damage from one of the test load collectives,
comparing (S5) the test degree of damage with the actual degree of damage,
outputting (S6) at least one control signal, on a basis of the comparison of the at least one test degree of damage with the actual degree of damage, the plurality of test load collectives are different with regard to distributions of amplitudes and frequency of loads on the at least one load-carrying component (1) over time, and
selecting (S7) the one of the test load collectives, which is used in deriving (S4) the test degree of damage, from among the plurality of test load collectives, with regard to the actual load collective determined.

14. The damage assessment method according to claim 13, further comprising, during determining (S2) the actual load collective detected during operation, accumulating information about the amplitudes and the frequency of loads on the at least one load-carrying component (1) over time.

15. The damage assessment method according to claim 13, further comprising, during comparing (S5) the test degree of damage with the actual degree of damage, determining a ratio between the actual degree of damage and the test degree of damage, and
during outputting (S6) the at least one control signal, associating predetermined functions with the control signal as a function of the ratio determined.

16. The damage assessment method according to claim 15, further comprising, as a function of the ratio determined during comparing (S5) the test degree of damage with the actual degree of damage, assigning to the control signal a function of producing (S6a) information about an expected residual life of the at least one load-carrying component (1) by estimation on a basis of the ratio determined between the actual degree of damage and the test degree of damage.

17. The damage assessment method according to claim 15, further comprising, as a function of the ratio determined in the step of comparing (S5) the test degree of damage with the actual degree of damage, assigning one of the following functions to the control signal:
commanding (S6b) at least one of recording of a fault entry in a fault memory and producing a warning message, if a first ratio is exceeded;
commanding (S6c) an intervention in the operation of the working machine to reduce the load on the at least one load-carrying component (1), if a second ratio, whose value is larger than that of the first ratio, is exceeded; and
commanding (S6d) that the working machine is to be operated in an emergency mode or that the working machine is to be switched off, if a third ratio, whose value is larger than the value of the second ratio, is exceeded.

18. The damage assessment method according to claim 17, further comprising defining the first, the second and the third ratios between the actual degree of damage and the test degree of damage as being variable as a function of at least one of an operating mode and a characteristic of the loading of the at least one load-carrying component (1).

19. The damage assessment method according to claim 13, further comprising carrying out continuously at least one of:
1) determining (S2) the actual load collective, and
2) comparing (S5) the test degree of damage with the actual degree of damage,
at least during the operation of the at least one load-carrying component (1).

20. A control unit (3) for assessing damage to at least one load-carrying component (1) of a working machine, the control unit (3) comprises: a signal input (4) for receiving a detection signal from a load detection element (5) for detecting a load on the at least one load-carrying component (1), a processor (6) for processing the detection signal and a signal output (7) for emitting at least one control signal, and a memory device (8) for storing information about a plurality of test load collectives, such that the control unit (3) is designed to determine an actual degree of damage to the at least one load-carrying component (1) on a basis of the detection signal from the load detecting element (5), to derive a test degree of damage from one of the test load collectives stored in the memory device (8), and, on a basis of a comparison between the test degree of damage and the actual degree of damage, to emit a control signal associated with a predetermined function, the memory device (8) is designed to store the plurality of test load collectives, which differ with regard to a distribution of amplitudes and frequency of loads on the at least one load-carrying component (1) over time, and such that the control unit (3) is designed to select, from among the plurality of test load collectives, a test load collective, which will be used for deriving the test degree of damage, with regard to the actual load collective determined.

21. The control unit (3) according to claim 20, wherein the control signals emitted, via the signal output (7), are associated with at least one of functions for displaying information and functions for intervening in operation of the working machine, and the control unit (3) is designed to carry out the method for assessing damage to at least one load-carrying component (1) of a working machine (2), the method comprising:
retaining (S1a) a plurality of test load collectives, which were determined during testing of the at least one load-carrying component (1), for derivation of a test degree of damage;
determining (S2) an actual load collective during operation of the at least one load-carrying component (1);
determining (S3) an actual degree of damage to the at least one load-carrying component (1) on a basis of the actual load collective determined;
deriving (S4) the test degree of damage from one of the test load collectives;
comparing (S5) the test degree of damage with the actual degree of damage; outputting (S6) at least one control signal on a basis of the comparison of the at least one test degree of damage with the actual degree of damage, the plurality of test load collectives are different with regard to distributions of amplitudes and frequency of loads on the at least one load-carrying component (1) over time; and
selecting (S7) the one of the test load collectives, which is used in deriving (S4) the test degree of damage, from among the plurality of test load collectives, with regard to the actual load collective determined.
